(19) United States
(12) Patent Application Publication
(10) Pub. No.: US 2011/0307784 A1
(43) Pub. Date: Dec. 15, 2011

(54) AV APPARATUS

(75) Inventor: Tomoki Kobayashi, Iwaki (JP)

(73) Assignee: Alpine Electronics, Inc., Tokyo (JP)

(21) Appl. No.: 13/111,616

(22) Filed: May 19, 2011

(30) Foreign Application Priority Data
Jun. 10, 2010 (JP) 2010-136981

(51) Int. Cl. G06F 3/048

(52) U.S. Cl. 715/716

(57) ABSTRACT

A scrollable list of AV contents to be displayed in an AV apparatus which outputs AV contents is provided. If the scrolling on an artwork list stops, the album attribute text of albums included in an artwork list is read from a portable music player. After that, the artworks of the albums are read from the portable music player from the album having its artwork at the center of the artwork list in the increasing order of the distances of display positions of the artworks to the artwork at the center. If the scrolling on the artwork list starts, the album attribute text of albums is read from the portable music player from the album having its artwork at the center of the artwork list in ascending order of the album numbers.

### RELATED APPLICATION

The present application claims priority to Japanese Patent Application Number 2010-136981, filed Jun. 10, 2010, the entirety of which is hereby incorporated by reference.

### BACKGROUND OF THE INVENTION

1. Field of the Invention

The present invention relates to a technology which allows a list of AV contents to be displayed in a scrollable manner in an AV apparatus which outputs AV contents.

2. Description of the Related Art

In order to allow a list of AV contents to be displayed in a scrollable manner in an AV apparatus which outputs AV contents, an audio player which reproduces a tune has been known to display a list of artworks, which are images associated with albums, in a scrollable manner, and display attribute information such as a title and an artist of an album positioned at the center of the list. The audio player receives the selection of an album by a user in the list of the artworks (as in Japanese Unexamined Patent Application Publication No. 2002-082745, for example).

In order to play on an audio player a tune stored in an external portable music player, a list of artworks associated with albums stored in the portable music player may be displayed in a scrollable manner. In this case, however, the following problems may occur.

That is, because reading the artworks from the portable music player may take a relatively long period of time, the reading may not catch up with the speed of the scrolling display, sometimes resulting in no display of the artworks and/or attribute information such as the titles and artists of the albums.

### SUMMARY OF THE INVENTION

Accordingly, it is an object of the present invention to allow for a more normal display of artworks and/or attribute information in an AV apparatus which displays in a scrollable manner a list of artworks of AV contents stored in an external device.

In order to achieve the object, there is provided an AV apparatus, which is connected to an external device storing a plurality of ordered AV contents and images associated with the AV contents, and which outputs an AV content stored in the connected external device, the AV apparatus including an image list display unit which displays a part of a list having the images associated with the AV contents stored in the external device in the order of the AV contents to which the images are associated as an image list in a scrollable manner, and an AV content receiving unit which receives the AV content associated with an image disposed at a specific position in the image list as the AV content selected by a user in accordance with an operation by the user, wherein the image list display unit reads the images to be arranged on the image list to be displayed from the connected external device in the increasing order of the distances from the positions of the images to be arranged on the image list to the specific position, and uses the read images to display the image list.

In order to achieve the object, there is provided an AV apparatus, which is connected to an external device storing a plurality of ordered AV contents and images associated with the AV contents, and which outputs an AV content stored in the connected external device, the AV apparatus including a reading unit which reads the images from the connected external device and holds the read images as read data, a list display unit which displays a part of a list having the images associated with the AV contents stored in the external device in the order of the AV contents to which the images are associated as an image list in a scrollable manner, and an AV content receiving unit which receives the AV content associated with an image disposed at a specific position in the image list as the AV content selected by a user in accordance with an operation by the user, wherein the list display unit uses the images held as the read data to display the image list, and the reading unit reads those images which have not been held as the read data among images to be arranged on the image list to be displayed by the list display unit when scrolling on the image list stops, from the connected external device, in the increasing order of the distances from the display positions of the images on the image list to the specific position, and holds them as the read data.

Therefore, the AV apparatus can reduce the maximum amount of the time required for displaying images in the image list as the distance from the position where an image is disposed to a specific position where an image of an AV contents selectable by a user is disposed decreases, that is, as the degree of focus by a user increases.

In the AV apparatus, where the external device stores text describing an attribute of an AV content stored in the external device, the reading unit reads the text from the connected external device and holds it as read data. The AV apparatus further includes an attribute display unit which reads an AV content or AV contents associated with one or a plurality of images, including at least the image at the specific position on the image list among images on the image list as an attribute-target-displayed AV content or contents, and which displays an attribute for the attribute target display by using the text held as the read data. If scrolling the display in a sequentially increasing order of the turns of AV contents associated with the images included in the image list is started, the reading unit reads text which has not been held as the read data among text describing attributes of AV contents having later turns than the AV content being the attribute-target-displayed AV content when the scrolling display starts in the order of the AV contents until the scrolling display is stopped, and if scrolling the display in the sequentially decreasing order of the turns of AV contents associated with the images included in the image list is started, the reading unit reads text which has not been held as the read data among text describing attributes of AV contents having earlier turns than the AV content being the attribute-target-displayed AV content when the scrolling display starts in the reverse order of the AV contents until the scrolling display is stopped.

This can prevent the failure of text to be displayed at points in time during scrolling on the image list because the text has not been read.

In the AV apparatus, the specific position on the image list may be a center position on the image list. In this case, the size of the image disposed at the center position on the image list is preferably larger than the size of the images disposed at other positions on the image list.

In the AV apparatus, the AV content may be an audio album. In this case, the AV apparatus may output the audio album which is an AV content received by the AV content receiving unit as the AV content selected by a user.

In order to achieve the object, there is provided an AV apparatus which is connected to an external device storing a plurality of ordered AV contents and images associated with the AV contents, and which outputs an AV content stored in the connected external device, the AV apparatus including a reading unit which reads the image from the connected external device and holds the read images as read data, a list display unit which displays a part of a list having the images associated with the AV contents and text describing attributes of the AV contents stored in the external device in the order of the AV contents to which the images are associated as an image list in a scrollable manner, and an attribute display unit which reads an AV content associated with at least one image included in the image list as an attribute-target-displayed AV content or contents, and which displays an attribute for the attribute target display by using the text held as the read data. In this case, if a scrolling display in a sequentially increasing order of the turns of AV contents associated with the images included in the image list is started, the reading unit reads text which has not been held as the read data among text describing attributes of AV contents having later turns than the AV content being the attribute-target-displayed AV content when the scrolling display starts in the order of the AV contents until the scrolling display is stopped. If a scrolling display in a sequentially decreasing order of the turns of AV contents associated with the images included in the image list is started, the reading unit reads text which has not been held as the read data among text describing attributes of AV contents having earlier turns than the AV content being the attribute-target-displayed AV content when the scrolling display starts in the reverse order of the AV contents until the scrolling display is stopped.

This can prevent the failure of text to be displayed at points in time during scrolling on the image list because the text has not been read.

In the AV apparatus, the AV content may be an audio album, and the text describing an attribute of an AV content may be text describing at least one of the album title and artist of the audio album which is the AV content.

According to the present invention, a more normal display of artworks and/or attribute information is allowed in an AV apparatus which displays in a scrollable manner a list of artworks of AV contents stored in an external device.

### BRIEF DESCRIPTION OF THE DRAWINGS

FIG. 1 is a block diagram illustrating a configuration of an audio apparatus according to an embodiment of the present invention;

FIG. 2 illustrates external contents management data according to the embodiment of the present invention;

FIGS. 3A1 to 3B2 illustrate album select windows according to the embodiment of the present invention;

FIG. 4 illustrates a scroll operation on an artwork list according to the embodiment of the present invention;

FIGS. 5A and 5B are flowcharts illustrating forward reading processing and management data reading control processing according to the embodiment of the present invention;

FIGS. 6A and 6B are flowchart flowcharts illustrating current-screen reading processing and forward/reverse scroll reading processing according to the embodiment of the present invention;

FIGS. 7A to 7C are diagrams illustrating operations in the management data reading control processing according to the embodiment of the present invention; and

FIGS. 8A to 8D are diagrams illustrating other examples of the album select window according to the embodiment of the present invention.

### DESCRIPTION OF THE PREFERRED EMBODIMENTS

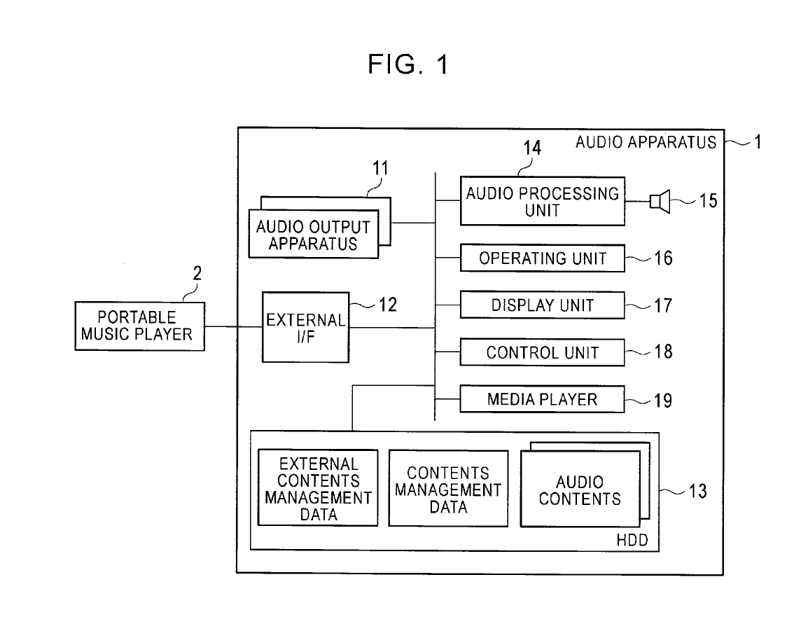

An embodiment of the present invention will be described below with reference to an example in which the invention is applied to an audio apparatus. FIG. 1 illustrates a configuration of an audio apparatus according to the embodiment. An audio apparatus 1 is mounted in an automobile and includes an audio output apparatus 11, an external interface 12, a Hard Disk Drive 13 (“HDD”, an audio processing unit 14, a speaker 15, an operating unit 16, a display unit 17, a control unit 18, and a media player 19. The audio output apparatus 11 outputs audio data, such as from a radio tuner or a CD/DVD player. The HDD 13 here records a plurality of external contents management data describing tunes and contents management data describing management information on each of the external contents management data.

The audio apparatus 1 however may be configured in hardware by a computer having a general configuration including a microprocessor, memory and other peripheral devices. In this case, the control unit 18, audio processing unit 14 and/or media player 19 in the audio apparatus 1 may be implemented by executing a program or programs prepared in advance by a microprocessor, for example. The program or programs may be provided to the audio apparatus 1 through a recording medium or a proper communication path.

A portable music player 2 may be connected to the external interface 12. The portable music player 2 may prestore external contents management data describing a tune and management information on the external contents management data. In this configuration, the audio processing unit 14 has a function of decoding as necessary and outputting the sound representative of input audio data to the speaker 15. The control unit 18 performs the processing and receiving of a setting regarding an audio source selected among the audio output apparatus 11, HDD 13, and portable music player 2 by a user through the operating unit 16. If the audio output apparatus 11 is set as the audio source, the control unit 18 controls the operation of the audio output apparatus 11 in accordance with a user operation selected by a user through the operating unit 16, and at the same time causes the speaker 15 to output the sound representative of audio data output by the audio output apparatus 11 to the audio processing unit 14.

On the other hand, if the HDD 13 is set as the audio source, the media player 19 uses contents management data storing management information on external contents management data recorded in the HDD 13 to provide a proper GUI on the display unit 17, and through the operating unit 16, receives a play control operation on external contents management data recorded in the HDD 13. In accordance with a play control operation received through the GUI, the media player 19 sets the external contents management data to be played and causes the audio processing unit 14 to output the external contents as sound representative of the audio data of the management data to be played through the speaker 15.

The media player 19 further reads management information on external contents management data stored in the portable music player 2 and stores the external contents management data to the HDD 13. If the portable music player 2 is set as the audio source, the media player 19 uses external contents management data to provide a GUI with a display of an album select window displayed on the display unit 17 as the proper GUI, and through the operating unit 16, receives a play control operation on external contents management data recorded in the HDD 13. The media player 19 receives the selection of an album or tune on the album select window of the GUI from the portable music player 2 and sets the album or tune to be played. If the album to be played is set, the media player 19 causes the portable music player 2 to sequentially output the audio data on the external contents management data of the tunes contained in the album to be played and causes the audio processing unit 14 to output the sound representative of the audio data output by the portable music player 2 to the speaker 15. If a tune to be played is set, the media player 19 causes the portable music player 2 to output the audio data of the external contents management data corresponding to the tune set to be played and causes the audio processing unit 14 to output the sound representative of the audio data output by the portable music player 2 to the speaker 15.

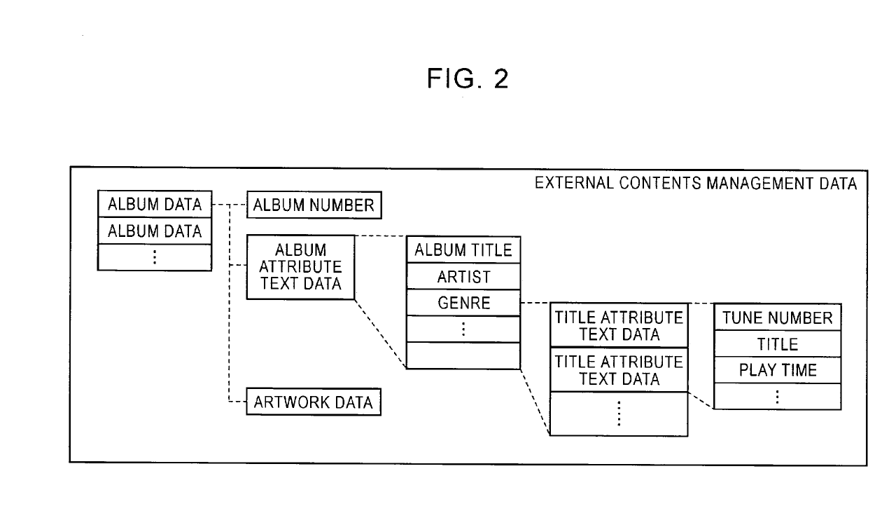

FIG. 2 illustrates external contents management data recorded in the HDD 13. The external contents management data corresponds to album information for managing an album.

As illustrated in FIG. 2, the external contents management data has album data provided for each album to which one tune corresponding to external contents management data stored in the portable music player 2 belongs. Each album data includes an album number which indicates a turn of the album in the portable music player 2, album attribute text data, and artwork data.

The album attribute text data describes an attribute of an album in text and may include the album title of the album, the artist or artists of the album, and the genre of the album, for example. The album attribute text data describes a tune included in the album and includes title attribute text data provided for each tune having the corresponding external contents management data recorded in the portable music player 2. Each title attribute text data describes an attribute of a tune in text and may include a tune number which describes the turn of the tune within the album, the title of the tune and the play time of the tune, for example.

The album artwork data is image data which is an image (normally a jacket photograph of the album) to be used as an artwork of the album.

The album attribute text data and the artwork data may be read from the portable music player 2 to the audio apparatus 1 independently and separately.

Next, an album select window will be described which is displayed on the display unit 17 as a GUI for receiving a play control operation on external contents management data recorded in the HDD 13. This description is made with reference to the external contents management data.

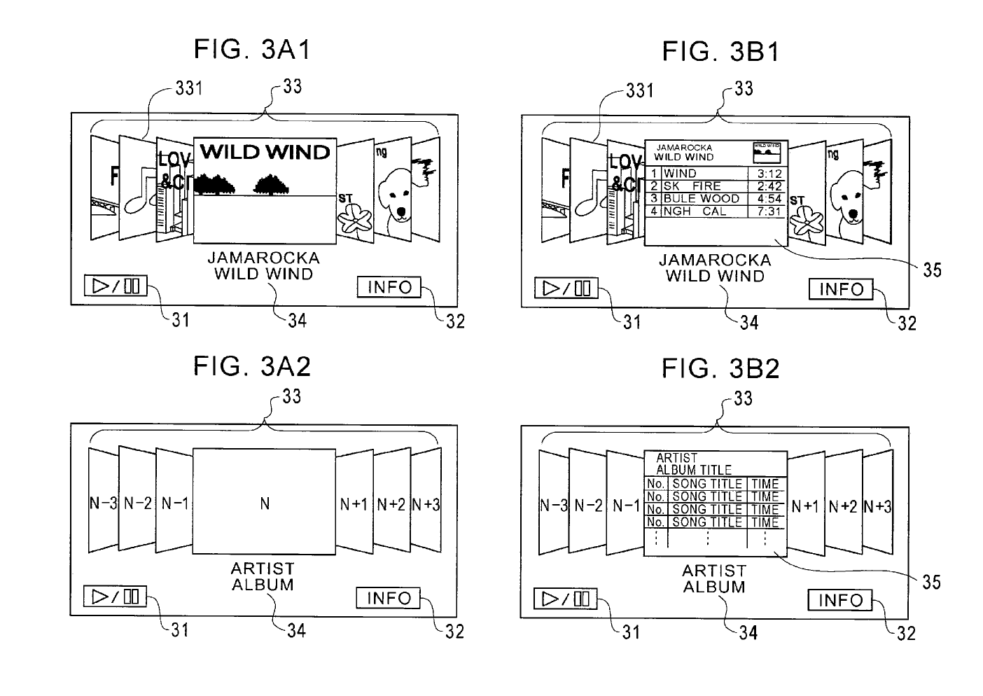

FIG. 3A1 illustrates a display example of a basic form of the album select window, and FIG. 3B1 illustrates a display example of a tune display form within an album on the album select window. The basic form of the album select window appears when the album select window is first displayed. As illustrated in FIG. 3A1, the album select window includes a play/pause button 31, an INFO button 32, an artwork list 33 having seven artworks displayed in line, and an album attribute display 34 providing an artist and the album title.

FIG. 3A2 schematically illustrates the configuration of the artwork list 33 having the album numbers on corresponding artworks at the respective positions of the artworks. The seven artworks displayed in the artwork list 33 are artworks described by artwork data of the album data of the seven albums having serial album numbers (albums having album numbers N−3 to N+3 are shown in FIG. 3A2). The smaller the album numbers are, the more left the corresponding artworks are positioned. However, as illustrated in FIG. 3A1, if the artwork data of the artwork to be displayed on the artwork list 33 has not been read to the album data in external contents management data, a dummy artwork 331 is provided in the artwork list 33 instead of the artwork (the artwork of the album having the album number N−2 in FIG. 3A2, for example.) On the other hand, if the artwork data of the album displaying the dummy artwork 331 instead of its artwork is read to the external contents management data during the display of the dummy artwork 331, the display of the dummy artwork 331 in the artwork list 33 is updated with the display of the artwork described by the read artwork data at that time.

Next, the album of the artwork positioned at the center of the artwork list 33 (the album having an album number N in FIG. 3A2) is automatically set as a selection candidate album. The artist and album title stored in the album attribute text data of the album data of the selection candidate album is displayed as an album attribute display 34 under the artwork of the selection candidate album.

When the album set as the selection candidate album is changed, the album attribute text data of the album data newly set as the selection candidate album may not be read into the external contents management data. At that time, the album attribute display 34 is not implemented. On the other hand, during a period of time when one album is being set as the selection candidate album, the album attribute text data of the album may be read into the external contents management data. In this case, at the time when it is read, the album attribute display 34 of the selection candidate album is implemented.

A user here is allowed to scroll the artworks displayed in the artwork list 33 by performing a forward scroll operation and/or reverse scroll operation with the operating unit 16. In other words, the media player 19 changes the range of album numbers of albums the artworks of which are to be displayed in the artwork list 33 in accordance with a forward scroll operation and/or reverse scroll operation with a scroll key and/or direction key provided in the operating unit 16 by a user.

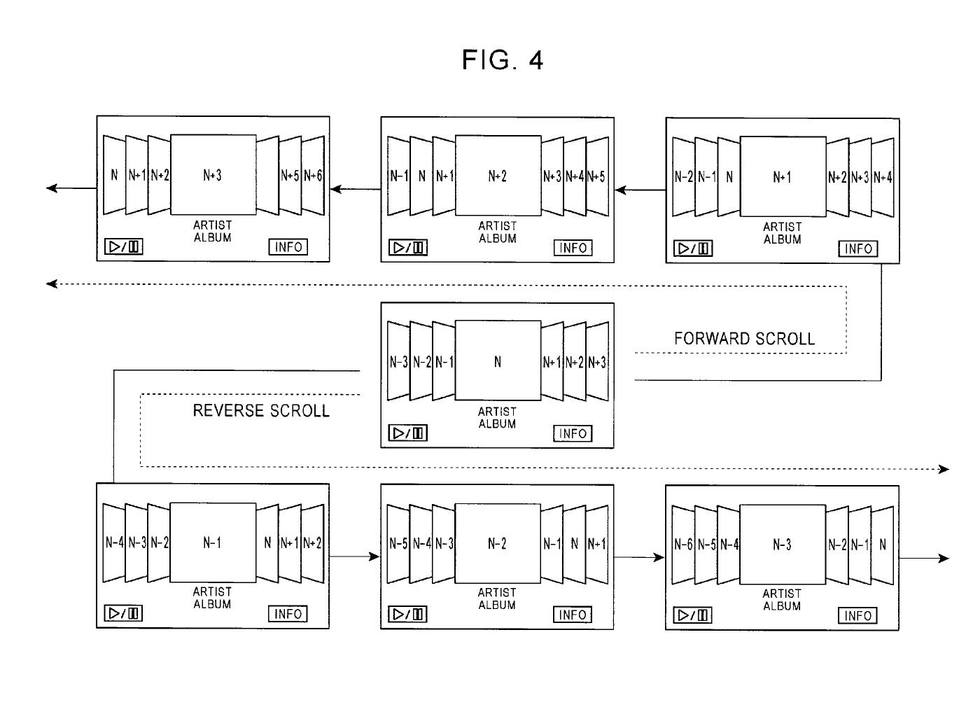

In other words, as illustrated in FIG. 4, during a period of time when the forward scroll operation is being performed, the range of album numbers of the albums the artworks of which are to be displayed in the artwork list 33 is sequentially updated to the direction that the album numbers contained in the range increase. During a period of time when the reverse scroll operation is being performed, the range of album numbers of the albums the artworks of which are to be displayed in the artwork list 33 is sequentially updated to the direction that the album numbers contained in the range decrease.

A user may scroll the artwork list display as illustrated in FIG. 4 so that an arbitrary album can be set as the selection candidate album, and the artist or artists and the album title can be displayed as the album attribute display 34.

While the album select window is being displayed in the basic form as described above, the play/pause button 31 may be operated. In this case, if the current external contents management data is being reproduced, the reproduction is stopped. If the current external contents management data is not being reproduced, the selection candidate album is set as the album to be played. The media player 19 then causes the portable music player 2 to sequentially output the audio data of the external contents management data of the tunes contained in the album set to be played and causes the audio processing unit 14 to output the sound representative of the audio data output by the portable music player 2 to the speaker 15.

While the album select window is being displayed in the basic form, the INFO button 32 may be operated. In this case, the media player 19 changes the display form of the album select window to a tunes-in-album display illustrated in FIG. 3B1.

The tunes-in-album display form of the album select window displays a tune list 35 of the selection candidate album instead of the display of artwork of the selection candidate album which is the album whose artwork is positioned at the center of the artwork list 33. The tune list 35 displays, as illustrated in the configuration of the tune list 35 in FIG. 3B2, a list of titles and play times of tunes contained in the selection candidate album, which are described in the title attribute text data in the album attribute text data in the album data of the selection candidate album. When the display form of the album select window is changed to the tunes-in-album display, the album attribute text data of the selection candidate album however may not have been read into the external contents management data. In this case, the tune list 35 is not displayed. On the other hand, when the display form of the album select window is the tunes-in-album display form and if the album attribute text data of the selection candidate album is read into the external contents management data, the tune list 35 is displayed when it is read.

A user can select a tune from the tune list 35. When a tune is selected from the tune list 35, the media player 19 sets the external contents management data corresponding to the selected tune as the external contents management data to be reproduced. The media player 19 then causes the portable music player 2 to output the audio data of the external contents management data set to be reproduced and causes the audio processing unit 14 to output the sound representative of the audio data output by the portable music player 2 to the speaker 15.

When the album select window is displayed in the tunes-in-album display form, the INFO button 32 may be operated. In this case, the media player 19 returns the display form of the album select window to the basic form illustrated in FIG. 3A1.

Next, operations will be described which are to be performed by the media player 19 in the audio apparatus 1 as described above for reading the management information on the external contents management data stored in the portable music player 2 and storing it as the external contents management data in the HDD 13.

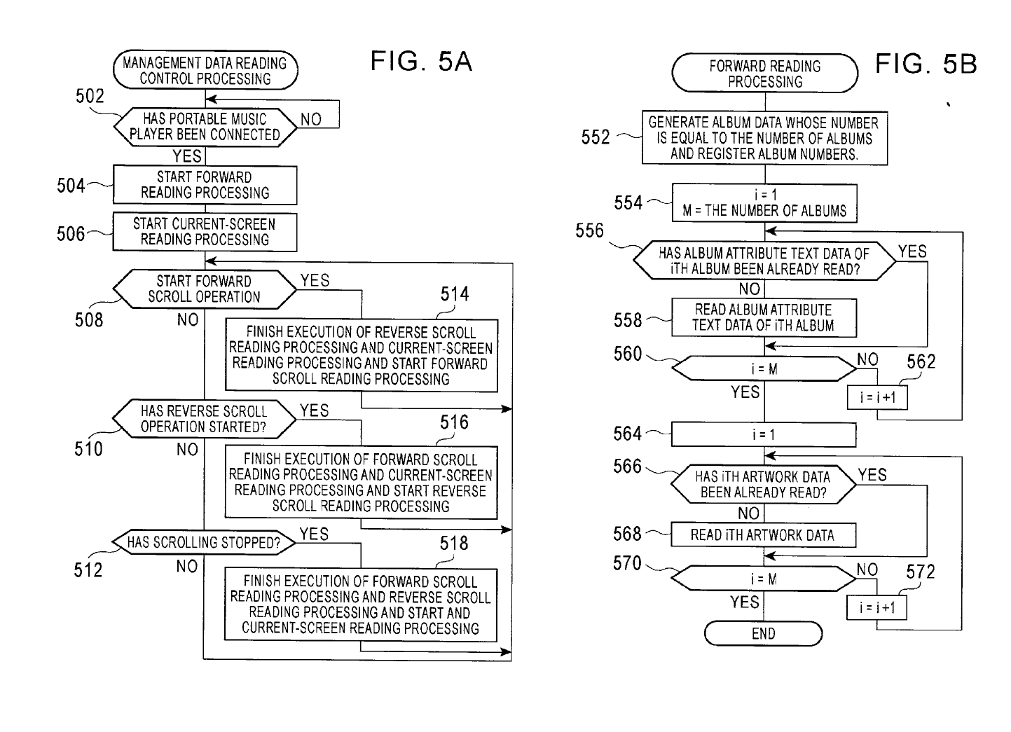

FIG. 5A illustrates management data reading control processing to be performed by the media player 19. The management data reading control processing begins to execute by the media player 19 when the audio apparatus 1 is started.

As illustrated in FIG. 5A, the management data reading control processing checks whether the portable music player 2 is connected to the audio apparatus 1 or not (step 502). If the portable music player 2 is connected, forward reading processing is immediately started. If the portable music player 2 is not connected, forward reading processing is started in response to the connection. (Step 504). Then, current-screen reading processing is started next (step 506).

After that, the processing monitors the start of a forward scroll operation on the artwork list 33 by a user (step 508), the start of a reverse scroll operation on the artwork list 33 by a user (step 510), and the stop of scrolling on the artwork list 33 (step 512).

If a forward scroll operation starts (step 508), processing being executed in the current-screen reading processing is finished, and forward scroll reading processing is started (step 514). If a reverse scroll operation is started (step 510), processing being executed in the current-screen reading processing and forward scroll reading processing is finished and reverse scroll reading processing is started (step 516). If the scrolling stops (step 512), the processing being executed in the reverse scroll reading processing and forward scroll reading processing is finished, and current-screen reading processing is started (step 518). These operations are repeated.

Next, the forward reading processing to be started in step 502 in the management data reading control processing will be described.

FIG. 5B illustrates a routine of the forward reading processing.

As illustrated in FIG. 5B, the processing acquires the number of albums managed with the album information from album information in the management information on the portable music player 2, creates album data corresponding to the number of albums in the external contents management data and stores serial album numbers in the album data (step 552).

Next, in ascending order of album numbers from the album under the first album number to the album under the last album number, whether the album attribute text data on the album has already been stored in the album data having the album number of the album in the external contents management data or not is checked (step 556) sequentially (steps 554, 560, 562) for each album. If it has not been stored, the album attribute text data of the album is read from the album information in the management information on the portable music player 2. The read album attribute text data is stored in the album data storing the album number of the album in the external contents management data (step 558).

After this processing stores the album attribute text data of the albums under all album numbers to the external contents management data, whether the artwork data of the album has already been stored in the album data having the album number of the album in the external contents management data or not is checked (step 566) sequentially (steps 564, 570, 572) for albums under the album numbers in ascending order of album numbers. If it has not been stored, the artwork data of the album is read from the album information in the management information on the portable music player 2 and is stored in the album data having the album number of the album in the external contents management data (step 568).

If this processing stores the artwork data of albums under all album numbers to the external contents management data, the forward reading processing ends. The three reading processes of the current-screen reading processing, forward scroll reading processing and reverse scroll reading processing are performed with higher priority to the forward reading processing. In other words, the execution of the forward reading processing is temporarily stopped while one of the three reading processes of the current-screen reading processing, forward scroll reading processing, and reverse scroll reading processing are performed. The execution is restarted when any of the three reading processes is no longer being executed.

Next, the current-screen reading processing started in step 504 or 518 in the management data reading control processing in FIG. 5A is started.

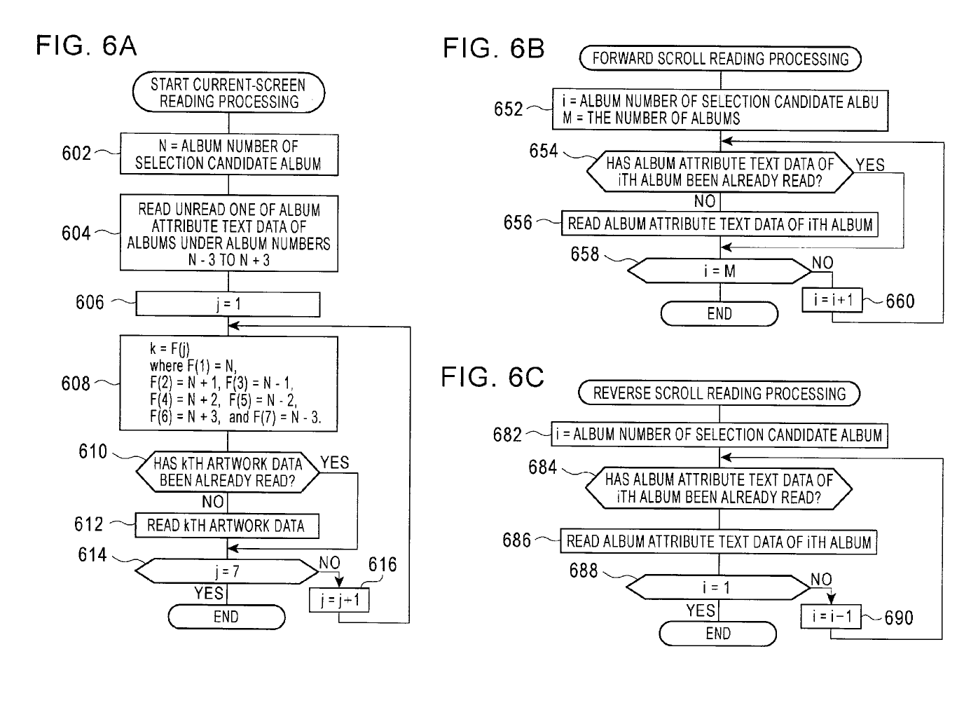

FIG. 6A illustrates a routine of the current-screen reading processing. As illustrated in FIG. 6A, this processing sets N as the album number of the selection candidate album, that is, the album whose artwork is being currently displayed at the center of the artwork list 33 (step 602). From the album attribute text data of the seven albums under the album numbers N−3 to N+3, one that has not been stored yet to the album data in the external contents management data is read from the album information in the management information on the portable music player 2 and is stored to the album data corresponding to the external contents management data (step 604).

Next, in the order of the album numbers N, N+1, N−1, N+2, N−2, N+3, and N−3, whether the artwork data of the albums have already stored in the album data in the external contents management data or not is checked (step 610) sequentially for the seven albums under the album numbers N−3 to N+3 (steps 606, 608, 614, and 616). If not, the artwork data is read from the album information in the management information on the portable music player 2 and is stored to the album data corresponding to the external contents management data (step 612).

If this processing is completed on all of the seven albums under the album numbers from N−3 to N+3, the current-screen reading processing ends.

Step 604 in the current-screen reading processing may check, for the seven albums under the album numbers from N−3 to N+3 sequentially in the order of the album numbers N, N+1, N−1, N+2, N−2, N+3, and N−3, whether the album attribute text data of the albums has already been stored to the album data of the albums in the external contents management data or not. If not, the album attribute text data of the album may be read from the album information in the management information on the portable music player 2 and may be stored to the corresponding album data.

Next, the forward scroll reading processing to be started in step 514 in the management data reading control processing will be described.

FIG. 6B illustrates a routine of the forward scroll reading processing.

As illustrated in FIG. 6B, for the albums from the album number of the selection candidate album, that is, the album whose artwork is being currently displayed at the center of the artwork list 33, to the last album number (steps 652, 658, 660), this processing checks whether the album attribute text data of the album has already been stored in the album data having the album number of the album in the external contents management data or not (step 654) sequentially in ascending order of the album numbers. If not, the album attribute text data of the album is read from the album information in the management information on the portable music player 2 and is stored to the album data having the album number of the album in the external contents management data (step 656).

If this processing completes to the last album number, the processing ends.

Next, the reverse scroll reading processing to be started in step 516 in the management data reading control processing will be described.

FIG. 6C illustrates a routine of the reverse scroll reading processing.

As illustrated in FIG. 6C, for the albums from the album number of the selection candidate album, that is, the album whose artwork is being currently displayed at the center of the artwork list 33, to the first album number (steps 682, 688, 690), this processing checks whether the album attribute text data of the album has already been stored in the album data having the album number of the album in the external contents management data or not (step 684) sequentially in descending order of the album numbers. If not, the album attribute text data of the album is read from the album information in the management information on the portable music player 2 and is stored to the album data having the album number of the album in the external contents management data (step 686).

If this processing completes to the first album number, the processing ends.

Up to this point, the management data reading control processing, forward reading processing, current-screen reading processing, forward scroll reading processing, and reverse scroll reading processing have been described.

According to the aforementioned processes, upon start and upon stop of scrolling on the artwork list 33 on the album select window, the current-screen reading processing performs the following process.

That is, among the album attribute text data of the albums whose artworks are included in the artwork list 33, one that has not been stored yet to the external contents management table is read from the album information in the management information on the portable music player 2 to the external contents management table.

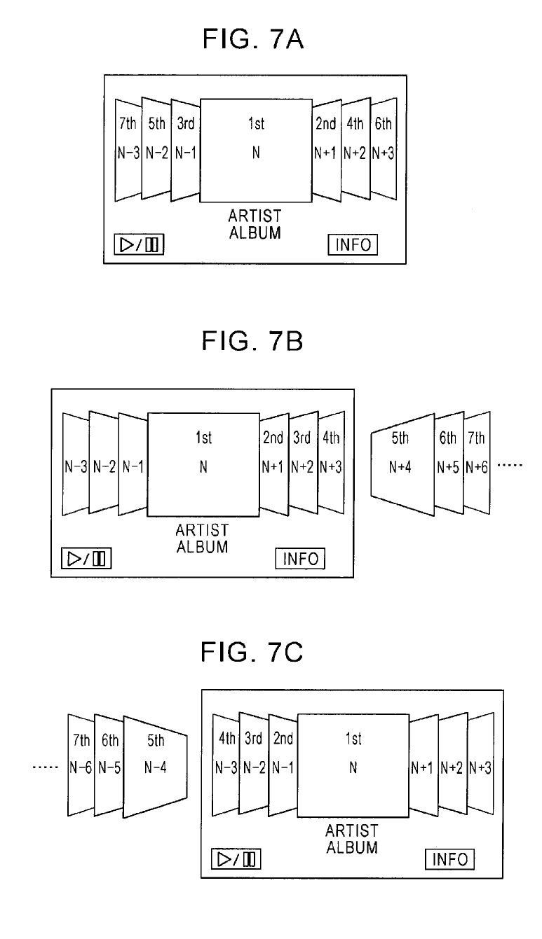

After that, those which have not been read yet to the external contents management table among the artwork data of the artworks of the albums whose artworks included in the artwork list 33 are read from the album information in the management information on the portable music player 2 to the external contents management table from the album (selection candidate album) of the artwork at the center of the artwork list 33 in the increasing order of the distances from the display positions to the artwork at the center, that is, in the increasing order of the distances from the album numbers to the selection candidate album, as in the order of “1st”, “2nd”, . . . , and “7th” in FIG. 7A.

This allows quick display of the album attribute display 34 of the selection candidate album, the tune list 35 of the selection candidate album, and/or the artworks of the artwork list 33 after the start or after stop of scrolling. This further can reduce the maximum amount of the time required for displaying an artwork in the artwork list 33 as the distances from the artwork to the center of the artworks decreases, that is, as the degree of focus by a user increases.

On the other hand, if the forward scrolling on the artwork list 33 on the album select window is started, the forward scroll reading processing reads the album attribute text of the albums from the album information in the management information on the portable music player 2 to the external contents management table in ascending order of album numbers from the album (selection candidate album) having its artwork at the center of the artwork list 33, therefore, in the order to be the selection candidate album with the forward scrolling, as in the order of “1st”, “2nd”, . . . , and “7th” in FIG. 7A. The album attribute text is not read, however, if it has already been read to the external contents management table.

This can prevent the failure of the album attribute display 34 of the selection candidate album at points in time during the forward scrolling due to the lack of the album attribute text of the selection candidate album (the album whose art work is displayed at the center of the artwork list 33) read to the external contents management table.

If the reverse scrolling on the artwork list 33 on the album select window is started, the reverse scroll reading processing reads the album attribute text of the albums from the album information in the management information on the portable music player 2 to the external contents management table in descending order of album numbers from the album (selection candidate album) having its artwork at the center of the artwork list 33, therefore, in the order to be the selection candidate album with the reverse scrolling, as in the order of “1st”, “2nd”, . . . , and “7th” in FIG. 7A. The album attribute text is not read, however, if it has already been read to the external contents management table.

This can prevent the failure of the album attribute display 34 of the selection candidate album at points in time during the reverse scrolling due to the lack of the album attribute text of the selection candidate album (the album whose art work is displayed at the center of the artwork list 33) read to the external contents management table.

Up to this point, an embodiment of the present invention has been described.

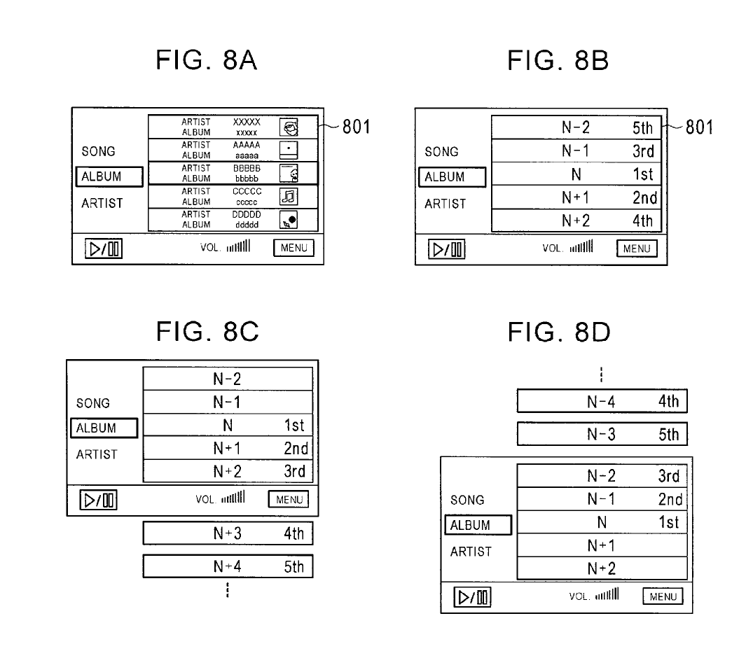

The embodiment may be applicable to an album select window, as illustrated in FIG. 8A, having an album list 801 displaying lists of artworks and album attributes (such as album titles and artist names).

The album list 801 displays the artworks and album attributes of a plurality of albums having serial album numbers, as illustrated in FIG. 8B. The album having its artwork and album attribute at the center of the album list 801 is handled as the selection candidate album.

The range of album numbers of albums having their artworks and album attributes displayed in the album list 801 is sequentially updated in the direction that the album numbers contained in the range increase in accordance with a forward scroll operation by a user. The range is sequentially updated in the direction that the album numbers contained in the range decrease in accordance with a reverse scroll operation by a user.

Upon start and upon stop of scrolling on the album list 801, the current-screen reading processing reads one that has not been stored yet to the external contents management table from the album information in the management information on the portable music player 2, among the album attribute text data of the albums contained in the album list 801 from the album information in the management information on the portable music player 2. After that, the current-screen reading processing reads those which have not been read yet to the external contents management table among the artwork data of the artworks of the albums included in the album list 801 from the album information in the management information on the portable music player 2 from the album (selection candidate album) at the center of the album list 801 in the increasing order of the distances from the display positions to the album at the center, that is, in the increasing order of the distances from the album numbers to the selection candidate album, as in the order of “1st”, “2nd”, . . . , and “5th” in FIG. 8B.

If a forward scrolling operation on the album list 801 is started, the forward scroll reading processing reads the album attribute text of the albums from the album information in the management information on the portable music player 2 to the external contents management table in ascending order of album numbers from the album (selection candidate album) at the center of the album list 801 therefore, in the order of the selection candidate album with the forward scrolling, as in the order of “1st”, “2nd”, . . . , and “5th” in FIG. 8C. The album attribute text is not read, however, if it already has been read to the external contents management table.

If a reverse scrolling operation on the album list 801 is started, the forward scroll reading processing reads the album attribute text of the albums from the album information in the management information on the portable music player 2 to the external contents management table in descending order of album numbers from the album (selection candidate album) at the center of the album list 801 therefore, in the order of the selection candidate album with the reverse scrolling, as in the order of “1st”, “2nd”, . . . , and “5th” in FIG. 8D. The album attribute text is not read, however, if it has already been read to the external contents management table.

This embodiment may be implemented by replacing the music player by an external apparatus which handles arbitrary AV contents such as a tune and a video title and replacing the audio apparatus 1 by an AV apparatus which outputs the corresponding AV contents.

While there has been illustrated an described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teaching of the invention without departing from the central scope thereof. Therefore, it is intended that this invention not be limited to the particular embodiments disclosed, but that the invention will include all embodiments falling within the scope of the appended claims.

What is claimed is:

1. An AV apparatus which is connected to an external device storing a plurality of ordered AV contents and images associated with the AV contents, and which outputs an AV content stored in the connected external device, the AV apparatus comprising:
an image list display unit which displays a part of a list having the images associated with the AV contents stored in the external device in the order of the AV contents to which the images are associated as an image list in a scrollable manner; and
an AV content receiving unit which receives the AV content associated with an image disposed at a specific position in the image list as the AV content selected by a user in accordance with an operation by the user,
wherein the image list display unit reads the images to be arranged on the image list to be displayed from the connected external device in the increasing order of the distances from the positions of the images to be arranged on the image list to the specific position, and uses the read images to display the image list.

2. The AV apparatus according to claim 1, wherein the specific position on the image list is a center position on the image list.

3. The AV apparatus according to claim 2, wherein:
the size of the image disposed at the center position on the image list is larger than the size of the images disposed at other positions on the image list.

4. The AV apparatus according to claim 1, wherein the AV content is an audio album, and the AV apparatus outputs the audio album which is an AV content received by the AV content receiving unit as the AV content selected by a user.

5. An AV apparatus which is connected to an external device storing a plurality of ordered AV contents and images associated with the AV contents, and which outputs an AV content stored in the connected external device, the AV apparatus comprising:
a reading unit which reads the images from the connected external device and holds the read images as read data;
a list display unit which displays a part of a list having the images associated with the AV contents stored in the external device in the order of the AV contents to which the images are associated as an image list in a scrollable manner; and
an AV content receiving unit which receives the AV content associated with an image disposed at a specific position in the image list as the AV content selected by a user in accordance with an operation by the user,
wherein the list display unit uses the images held as the read data to display the image list; and
the reading unit reads those images which have not been held as the read data among the images to be arranged on the image list to be displayed by the list display unit when scrolling on the image list stops, from the connected external device, in the increasing order of the distances from the display positions of the images on the image list to the specific position, and holds them as the read data.

6. The AV apparatus according to claim 5, wherein:
the external device stores text describing an attribute of an AV content stored in the external device;
the reading unit reads the text from the connected external device and holds it as read data;
the AV apparatus further comprising:
an attribute display unit which reads an AV content or AV contents associated with one or a plurality of images, including at least the image at the specific position on the image list among images on the image list as an attribute-target-displayed AV content or contents, and which displays an attribute for the attribute target display by using the text held as the read data;
wherein, if scrolling the display in a sequentially increasing order of the turns of AV contents associated with the images included in the image list is started, the reading unit reads text which has not been held as the read data among text describing attributes of AV contents having later turns than the AV content being the attribute-target-displayed AV content when the scrolling display starts in the order of the AV contents until the scrolling display is stopped; and
wherein, if scrolling the display in a sequentially decreasing order of the turns of AV contents associated with the images included in the image list is started, the reading unit reads text which has not been held as the read data among text describing attributes of AV contents having earlier turns than the AV content being the attribute-target-displayed AV content when the scrolling display starts in the reverse order of the AV contents until the scrolling display is stopped.

7. The AV apparatus according to claim 6, wherein:
the AV content is an audio album; and
the text describing an attribute of an AV content is text describing at least one of an album title and an artist of the audio album which is the AV content.

8. The AV apparatus according to claim 5, wherein:
The specific position on the image list is a center position on the image list.

9. The AV apparatus according to claim 8, wherein:
the size of the image disposed at the center position on the image list is larger than the size of the images disposed at other positions on the image list.

10. The AV apparatus according to claim 5, wherein the AV content is an audio album, and the AV apparatus outputs an audio album which is an AV content received by the AV content receiving unit as the AV content selected by a user.

11. An AV apparatus which is connected to an external device storing a plurality of ordered AV contents and images associated with the AV contents, and which outputs an AV content stored in the connected external device, the AV apparatus comprising:
a reading unit which reads the images from the connected external device and holds the read images as read data;
a list display unit which displays a part of a list having the images associated with the AV contents and text describing attributes of the AV contents stored in the external device in the order of the AV contents to which the images are associated as an image list in a scrollable manner; and
an attribute display unit which reads an AV content associated with at least one image included in the image list as an attribute-target-displayed AV content or contents, and which displays an attribute for the attribute target display by using the text held as the read data;
wherein, if scrolling the display in a sequentially increasing order of the turns of AV contents associated with the images included in the image list is started, the reading unit reads text which has not been held as the read data among text describing attributes of AV contents having later turns than the AV content being the attribute-target-displayed AV content when the scrolling display starts in the order of the AV contents until the scrolling display is stopped; and
wherein, if scrolling the display in the sequentially decreasing order of the turns of AV contents associated with the images included in the image list order is started, the reading unit reads text which has not been held as the read data among text describing attributes of AV contents having earlier turns than the AV content being the attribute-target-displayed AV content when the scrolling display starts in the reverse order of the AV contents until the scrolling display is stopped.

12. The AV apparatus according to claim 11, wherein:
the AV content is an audio album; and
the text describing an attribute of an AV content is text describing at least one of an album title and an artist of the audio album which is the AV content.
